(19) United States
(12) Patent Application Publication
(10) Pub. No.: US 2010/0020340 A1
(43) Pub. Date: Jan. 28, 2010

(54) METHOD AND SYSTEM FOR VISUAL CALIBRATION OF PRINTERS

(75) Inventor: David Paul Butler, Tigard, OR (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/180,346

(22) Filed: Jul. 25, 2008

(51) Int. Cl. G06F 15/00

(52) U.S. Cl. 358/1.9

(57) ABSTRACT

A method and system for improving visual calibration of a printing device is disclosed. A Pan-Dimensional Mechanism can be utilized for calibrating the printing device so that a gamma curve can be created once for each halftone. A grey calibration and a color calibration can be implemented under different light sources utilizing a comb pattern and a snowflake pattern for displaying color display parameters. A delta in value can be determined between composite greys associated with different light sources which can be added to an internal calibration value associated with a particular light source for color calibration. Such an approach can be implemented utilizing a touch screen front panel with various display methods for user interactions in order to set the color display parameters.

### TECHNICAL FIELD

Embodiments are generally related to calibration techniques. Embodiments additionally relate in general to the field of computers and similar technologies and, in particular, to software utilized in this field. Embodiments are also related to methods and systems for visual calibration of printing devices.

### BACKGROUND OF THE INVENTION

Color management is a process of attempting to match colors across input (e.g., scanners, digital cameras), display (e.g., computer monitors), and output devices (e.g., color printers). Computers and other electronic equipment have typically generated three-dimensional RGB (red, green, blue) color signals. Many printers, however, receive four-dimensional CMYK (cyan, magenta, yellow, and black) signals as input and print output colors which are measured as corresponding RGB values. A look-up table is commonly provided to convert each digital RGB color signal value to a corresponding digital CMYK value before being received by the printer. Color management software converts RGB and CMYK input color profiles to the color gamut of a specific output device.

Printer calibration is a process that is utilized to return the print engine to a known standard to achieve and maintain consistent color quality for each stock or color group and halftone. The calibration procedures adjust a printer so that it is in the same state as the printer characterized for the color look-up table. If the printer reacts just as the original printer which was characterized, then it will print the same and the output of the color look-up tables will also be the same.

The calibration of printers can be determined by using a visual calibration procedure in which a human observer substitutes for a measurement device. Visual calibration of printers must simultaneously satisfy several, often competing requirements. In color reproduction fields such as commercial printing and photography, it is known that the correlated color temperature of the viewing light affects the way in which an observer perceives a color image. More particularly, an observer will perceive the same color image differently when viewed under light sources having different correlated color temperatures. Because of these perceptual differences, conventional color reproduction practice accepts 5,000° K (hereinafter “D50”) as a standard white color temperature. In accordance with this convention, commercial color reproduction facilities ordinarily evaluate color images for color fidelity in a room whose light is controlled to a white color temperature of D50. A problem associated with this approach is that the printers may exhibit metamerism (i.e., images of printers calibrated under D50 light might appear different under other light sources).

Gamma is the relationship between the brightness of a pixel as it appears on the screen and the numerical value of that pixel. One reason gamma is a useful concept is that printer pixels are not square and usually overlap other pixels to some degree. This means that if an area has 50% of the pixels turned on, the area covered by the pixels is actually over 50%. This relationship will hereafter be called “dot gain”. The gamma level controls the saturation or density of an image, thus images without the proper gamma can appear either too light/washed-out or too dark/saturated. Gamma is often used to counteract dot gain (e.g. the gamma control may ask for 48% of the pixels in an area to be “on” to result in a 50% visual coverage). When the correct gamma is used, the images will be in true color and thus accurately represent the color of the image. This “gamma” is applied to each halftone in a printer. In a printer, there are 4 halftones (Cyan, Magenta, Yellow and Black) and thus 4 gammas for each print quality-mode/resolution (e.g. standard, photo, draft). In general, each quality-mode/resolution has a different dot gain and thus is distinctly different and thereby, in general, need to be calibrated separately.

Further, in the majority of prior art approaches, a user is able to balance the composite grey line, but is unable to adjust the lightness of the composite grey line. Similarly, while calibrating one set of calibrations these approaches throws off the adjustments made previously that are related to an independent set of calibrations.

Accordingly, a need exists for an improved method and system for visual calibration of printers under different light sources having different correlated color temperatures as described in greater detail herein.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide improved color calibration techniques.

It is another aspect of the present invention to provide a method, system and computer-usable medium for visual calibration of printing devices under light sources having different correlated color temperatures.

It is a further aspect of the present invention to provide for a method, system and computer-usable medium for adjusting both hue and gamma level of an image.

It is a further aspect of the present invention to provide for a method, system and computer-usable medium for adjusting all modes utilizing pan dimensional calibration.

It is an additional aspect of this presentation to provide a single instance of calibration, intended to affect multiple print modes/resolutions

The aforementioned aspects and other objectives and advantages can now be achieved as described herein. A method and system for improving visual calibration of a printing device is disclosed. A Pan-Dimensional-Calibration (PDC) mechanism can be utilized for calibrating the printing device. Further, but keeping track of the delta (i.e. difference) between D50 lighting and generalized office lighting, the same calibration results in D50 or normal office can be produced, where before D50 lighting would have been required.

A grey calibration and a color calibration can be implemented under different light sources utilizing a comb pattern and a snowflake pattern for displaying color display parameters. A delta in value can be determined between composite greys associated with different light sources which can be added to an internal calibration value associated with a particular light source for color calibration. Such an approach can be implemented utilizing a touch screen front panel with various display methods for user interactions in order to set the color display parameters.

A comb pattern and a snowflake pattern can be combined in order to adjust both hue and gamma associated with a composite grey line to more closely match a k-only grey line. The printer can be calibrated in different light sources such as “Normal Office Light.” or “D50”. The PDC mechanism utilizes the concept of six axes where the axes are independent and any adjustments made on the composite grey axis, will not effect the adjustments on other axes. The areas between the axes can be morphed depending on how close they are to an axis. The color calibration is dependent on the grey calibration and the grey calibration can encompass both pure K grey and composite grey.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a printer calibrating device, which can be implemented in accordance with the embodiment of the present invention;

FIG. 2 illustrates a schematic view of a computer system in which the present invention may be embodied;

FIG. 3 illustrates a schematic view of a software system including an operating system, software, and a user interface, which can be adapted for use in carrying out an embodiment of the present invention;

FIG. 4 illustrates an exemplary graphical user interface window for k-grey calibration, in accordance with a preferred embodiment;

FIG. 5 illustrates an exemplary graphical user interface window for composite grey calibration, in accordance with a preferred embodiment;

FIG. 6 illustrates an exemplary graphical user interface window for color calibration, in accordance with a preferred embodiment; and

FIG. 7 illustrates a detailed flow chart of operations illustrating logical operational steps of a method for improving visual calibration of printing devices, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of such embodiments.

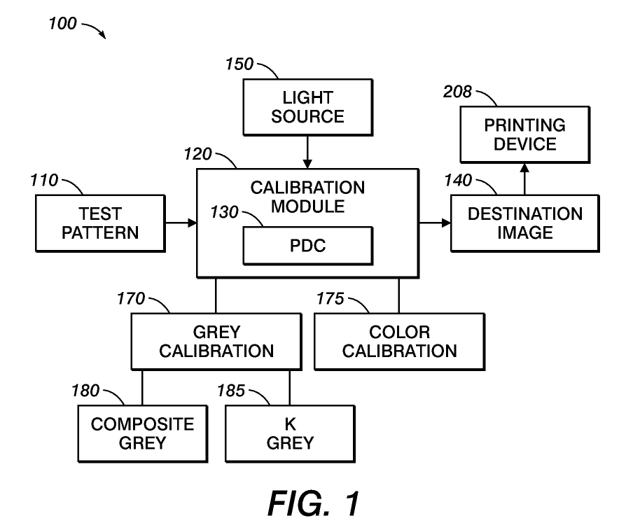

FIG. 1 illustrates a block diagram of a printer calibrating device 100, which can be implemented in accordance with the embodiment of the present invention. The printer calibrating device 100 typically includes a calibration module 120, a printing device 208, a light source 150 and a test pattern 110. The calibration module 120 resides in storage devices and controls the printing and color calibration of the printing device 208. The calibration module 120 is generally coupled to the printing device 208. The calibration module 120 calibrates the printing device 208 between swatches of composite grey that views under different light sources 150. The calibration module 120 implements calibration of the test pattern 110 using a Pan-Dimensional-Calibration (PDC) mechanism 130 that adjusts all the print quality and media modes in order to give similar appearance. The PDC mechanism 120 can be stacked with the PDC adjustments for each halftone and the printing device 208 would only need one calibration. The PDC mechanism 120 utilizes the concept of six axes C, M, Y, K (cyan, magenta, yellow, and black), RGB (red, green, blue) and a true grey-line. Each color can be morphed depending on its relationship to these axes (e.g., colors closest to cyan can be influenced most by the cyan PDC curve).

The PDC mechanism 120 can consider all axes to be independent. Hence, any adjustments made on a composite grey axis should not effect any adjustments on other axes. The areas between the axes can be morphed depending on how close they are to an axis. The printing device 208 can be calibrated under light sources such as “Normal Office Light” or “D50” illuminant. The calibration module 120 implements calibration such as a grey calibration 170 and a color calibration 175. The grey calibration 170 is dependent on the color calibration 175 and could not be entered until grey calibration 170 is completed for (e.g., a Green/Black calibration cannot be started until a Magenta/Cyan calibration has been completed). The grey calibration 170 can encompass both pure K grey calibration 185 and a composite grey calibration 180.

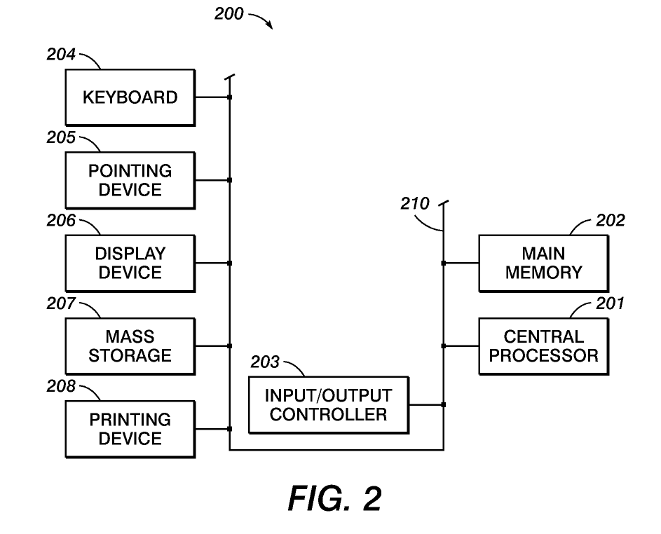

FIGS. 2-4 are provided as exemplary diagrams of data-processing environments in which embodiments of the present invention can be implemented. It should be appreciated that FIGS. 2-4 are only exemplary and are not intended to assert or imply any limitation with regard to the environments in which aspects or embodiments of the present invention can be implemented. Many modifications to the depicted environments can be made without departing from the spirit and scope of the present invention.

As depicted in FIG. 2, the present invention may be embodied in the context of a data-processing apparatus 200 comprising a central processor 201, a main memory 202, an input/output controller 203, a keyboard 204, a pointing device 205 (e.g., mouse, track ball, pen device, or the like), a display device 206, and a mass storage 207 (e.g., hard disk). Additional input/output devices, such as a printing device 208, can be included in the data-processing apparatus 200 as desired. As illustrated, the various components of the data-processing apparatus 200 communicate through a system bus 210 or similar architecture.

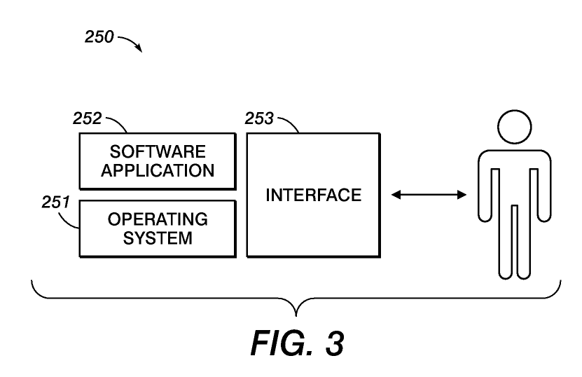

FIG. 3 illustrates a computer software system 250 provided for directing the operation of the data-processing apparatus 100. Software system 250, which is stored in system memory 202 and on disk memory 207, includes a kernel or operating system 251 and a shell or interface 253. One or more application programs, such as software application 252, can be “loaded” (i.e., transferred from storage 207 into memory 202) for execution by the data-processing apparatus 200. The data-processing apparatus 200 receives user commands and data through user interface 253; these inputs may then be acted upon by the data-processing apparatus 200 in accordance with instructions from operating module 251 and/or application module 252.

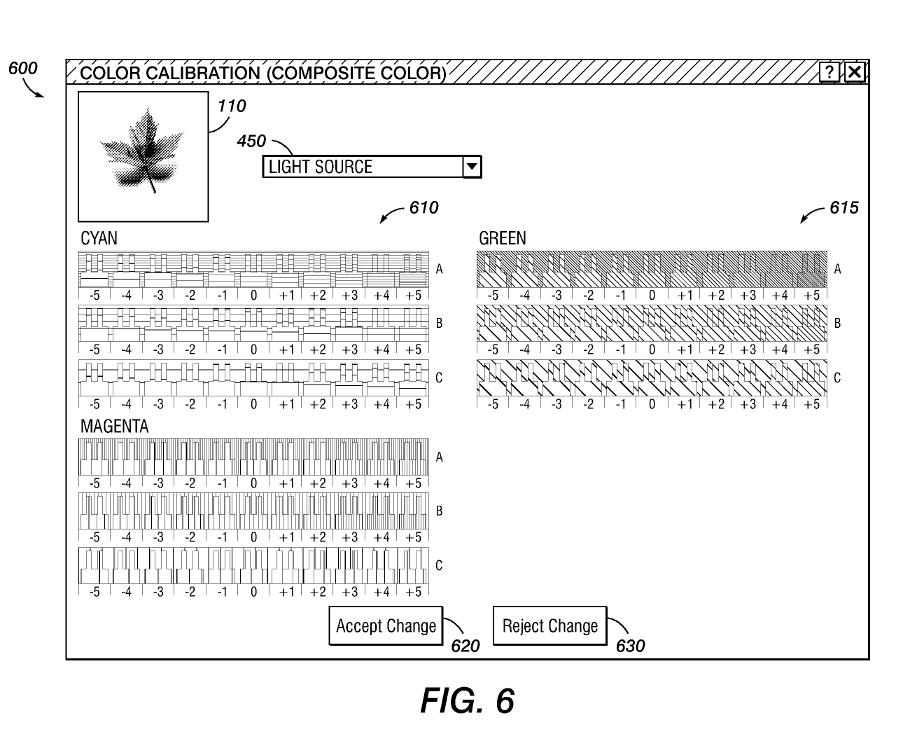

The interface 253, which is preferably a graphical user interface (GUI), also serves to display results, whereupon the user may supply additional inputs or terminate the session. In an embodiment, operating system 251 and interface 253 can be implemented in the context of a “Windows” system. Application module 252, on the other hand, can include instructions, such as the various operations described herein with respect to the various components and modules described herein, such as, for example, the method 600 depicted in FIG. 6.

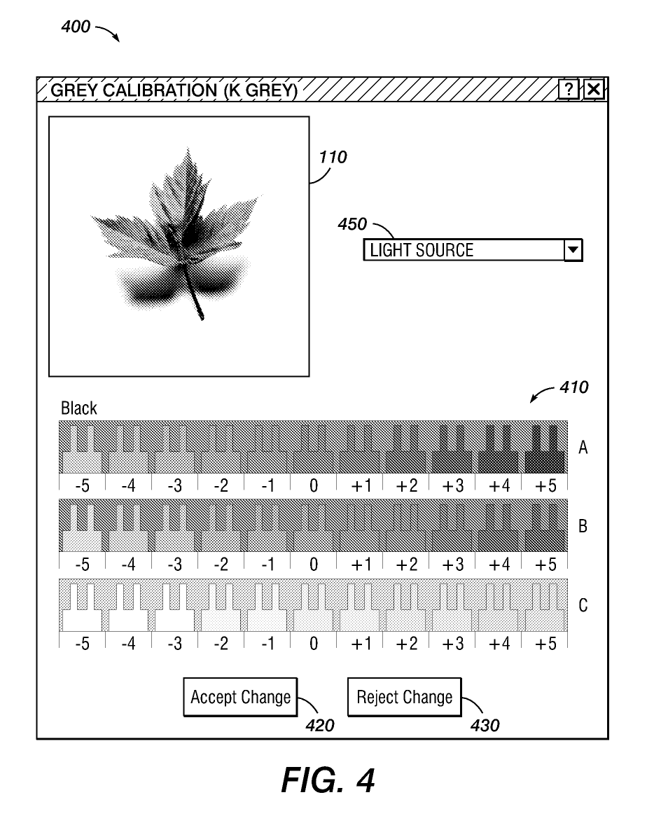

FIG. 4 illustrates an exemplary graphical user interface window 400 for k-grey calibration 185, in accordance with a preferred embodiment. Note that GUI window 400 can be implemented utilizing a GUI such as the GUI 253 depicted in FIG. 3 and can be provided by a module, such as, for example, module 252. GUI window 400 can be displayed via a display device such as display device 206 depicted in FIG. 2 and implemented via the GUI 253 or a control panel associated with the printing device 205. The GUI 400 can be a touch screen front panel so that a user can simply select the colors by touching the GUI window 400. The grey calibration window 410 represented in a comb pattern can be utilized to adjust the printer's green and black color. The user can choose the light source 150 such as “Normal Office Light” or “D50” illuminant by selecting the options listed in the combo box 450. Note that a combo box such as combo box 450 is a GUI element that indicates combination of a drop-down list or list box and a single-line textbox, allowing the user either to type a value directly into the control or choose from the list of existing options. The default can be a “Normal Office Light”.

The grey calibration 185 for cyan, magenta, green and black color can also be performed and the settings can be saved by accepting the changes by clicking the accept change button 420. The test pattern 110 can also be viewed with the adjusted color settings. The settings can also be discarded by clicking the discard change button 430. The control can move to calibrate color window as shown in FIG. 6 without saving any changes if the user clicks the discard change button 430 included within GUI window 400. The user could simply select the rectangle associated with the grey calibration window 410 that corresponds to the desired rectangle on the test pattern 110. The test pattern 110 can then be reprinted with the new adjustments.

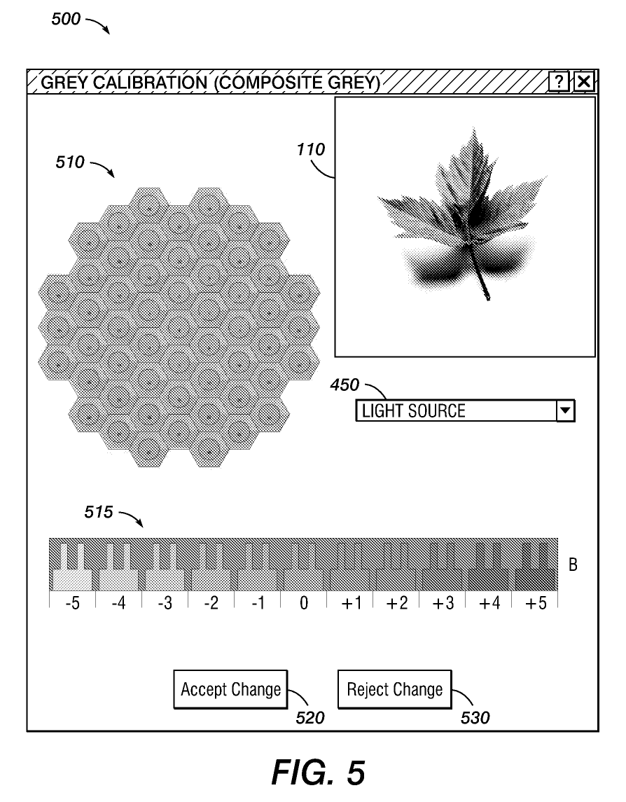

FIG. 5 illustrates an exemplary graphical user interface window 500 for composite grey calibration 180, in accordance with a preferred embodiment. Note that in FIGS. 1-7 identical and similar parts or elements are referred by identical reference numerals. The composite grey calibration 180 is very similar to the k grey calibration 185, but includes a comb pattern 515 where the top of the comb pattern 515 can be k grey 185 and the bottom of the comb pattern 515 can be the composite grey 180 and at the center position is a snowflake pattern 510. The circles in the snowflake pattern 515 are numbered from 0 to 54 that appears most neutral grey. The GUI 500 automatically displays the effect of adjustments of the test pattern 110. The color balance is set properly when the circle in snowflake pattern 515 that appears most neutral grey is circle 0.

The changes can be saved by clicking the accept change button 520 and can be discarded by clicking the discard change button 530. When the center of the snowflake pattern 510 is neutral grey and the composite grey is at position “0” on the comb pattern 515, the lightness of the k value grey should match. The two graphics, the snowflake pattern 510 and the comb pattern 515 can be represented on the touch screen of the GUI 500 so that the user can select the one that corresponds best to the printed page of the test pattern 110. The test pattern 110 can then be reprinted using the new adjustments. If the user chooses to only do “Calibrate Grey”, then the relative curves for cyan, magenta, and yellow will be propagated to the other parts of the PDC 130.

FIG. 6 illustrates an exemplary graphical user interface window 600 for color calibration 175, in accordance with a preferred embodiment. It should be appreciated that the particular implementations shown and described in FIGS. 4-6 are merely exemplary and are not intended to limit the scope of the present invention in any way. The comb pattern 610 adjusts the printing device cyan and magenta color settings and the comb pattern 615 for green color settings. The GUI 600 can also be extended so that the user can be allowed to adjust for red and blue colors. The color calibration 175 is dependent on the grey calibration 170 hence color calibration 175 cannot be entered until grey calibration 170 is completed.

The following description is presented with respect to embodiments of the present invention, which can be embodied in the context of a data-processing system such as data-processing apparatus 200 and a computer software system 250 as depicted respectively in FIGS. 2-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

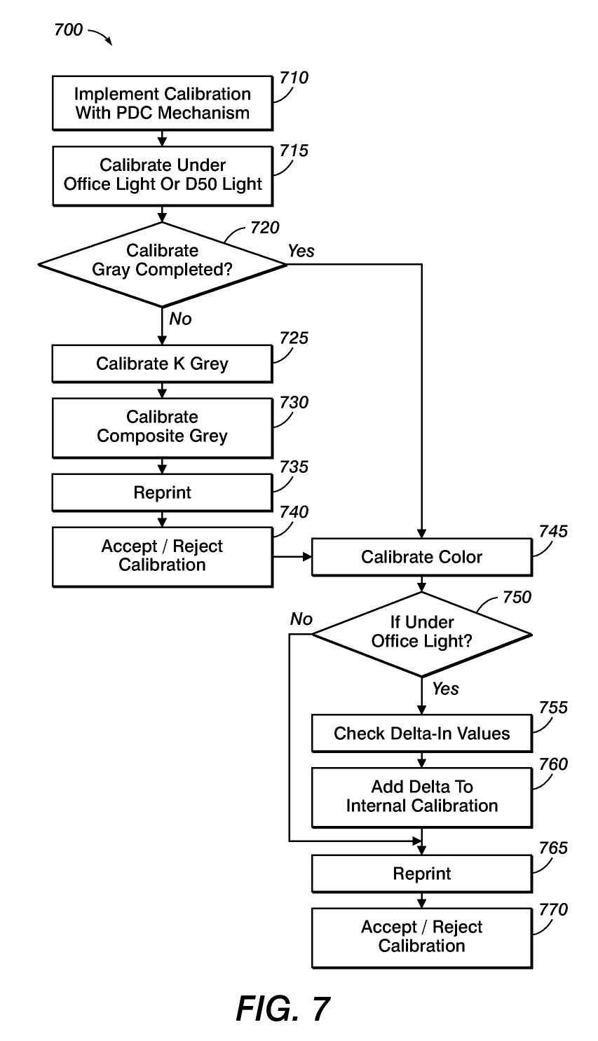

FIG. 7 illustrates a detailed flow chart of operations illustrating logical operational steps of a method 700 for improving printer calibration, which can be implemented in accordance with a preferred embodiment. Note that the method 700 can be implemented in the context of a computer-useable medium that contains a program product. A calibration can be implemented on a printing device 208 by a calibration module 120 associated with a PDC mechanism 130, as illustrated at block 710. The printing device 208 can be calibrated under office light or under D50 illuminant, as depicted at block 715. Thereafter, a determination can be made if a grey calibration 170 is completed, as depicted at block 720. If the grey calibration 170 is not completed, a k grey calibration 185 can be implemented as shown at block 725. A composite grey calibration 180 can also be implemented, as illustrated at block 730. A test pattern 110 can be reprinted with the adjusted color settings, as shown at block 735. The changes made can be accepted or rejected, as depicted at block 740.

If the grey calibration 170 is completed, then color calibration 175 can be initiated, as illustrated at block 745. A determination can be made if the calibration is done under office light, as shown at block 750. If the calibration is under normal office light, the calibration module 120 can check for the delta in values between a composite grey that looks right in D50 illuminant and a composite grey in normal office light, as illustrated at block 755. Thereafter, as depicted at block 760, the delta in values can be implicitly added to the internal calibration values associated with the normal office light. This means that calibrating in D50 light will be more accurate than normal office light because when calibrating for color D50 is a standard illuminant.

The calibration can be done at a set number of points between a swatch of composite grey which views as desired under D50 light, and a swatch of grey that views as desired under normal office light. Thus, when a user makes our set of grey points look good under office light, those adjustments can also be converted to D50 light. The test pattern 110 can be reprinted with the adjusted color settings, as shown at block 765. The changes made can be accepted or rejected, as depicted at block 770. If the calibration is not under normal office light, the changes made can be accepted or rejected, as depicted at block 770.

Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as, but not limited to, Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. Thus, the method 700 described herein can be deployed as process software in the context of a computer system or data-processing system as that depicted in FIGS. 2-3.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data-processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A computer implemented method for improving visual calibration of printers, comprising:
calibrating a printing device based on a color calibration and a grey calibration under at least one light source utilizing a Pan-Dimensional-Calibration (PDC) mechanism in order to create a gamma curve for correcting said printer color balance once for each halftone wherein said color calibration depends on said grey calibration; and
representing said color calibration and said grey calibration in at least one of: a touch screen utilizing a plurality of display patterns and responsive to user interaction, and printing a test pattern utilizing adjustments that can be accepted and rejected.

2. The method of claim 1 wherein said at least one light source comprises a normal office light and a D50 illuminant.

3. The method of claim 1 further comprising;
determining a delta in value between a composite grey associated with said at least one light source and implicitly adding said delta in value to an internal calibration value when said printing device is characterized for said color calibration in said normal office light.

4. The method of claim 2 further comprising;
determining a delta in value between a composite grey associated with said normal office light and said D50 illuminant and implicitly adding said delta in value to an internal calibration value when said printing device is characterized for said color calibration in said normal office light.

5. The method of claim 3 wherein said at least one light source comprises a normal office light and a D50 illuminant.

6. The method of claim 1 wherein said plurality of display patterns comprises a comb pattern and a snowflake pattern.

7. The method of claim 1 wherein said PDC mechanism comprises six axes that is independent to each other.

8. The method of claim 2 wherein said plurality of display patterns comprises a comb pattern and a snowflake pattern.

9. The method of claim 2 wherein said PDC mechanism comprises six axes that is independent to each other.

10. The method of claim 3 wherein said plurality of display patterns comprises a comb pattern and a snowflake pattern.

11. The method of claim 3 wherein said PDC mechanism comprises six axes that is independent to each other.

12. The method of claim 4 wherein said plurality of display patterns comprises a comb pattern and a snowflake pattern.

13. The method of claim 4 wherein said PDC mechanism comprises six axes that is independent to each other.

14. A method for calibrating a printing device under at least one of office light and D50 illuminant, comprising:
provide a printing device with a calibration module in association with a Pan-Dimensional-Calibration (PDC) mechanism;
implement k grey calibration and then composite grey if a grey calibration has not been completed, otherwise calibrate color;
print test pattern after implementing k grey and composite grey calibration to enable acceptance determination; and
determine delta in value between office light and D50 light if calibration is conducted under office light, otherwise print test pattern after color calibration to enable acceptance determination.

15. The method for calibrating a printing device under at least one of office light and D50 illuminant of claim 14, further comprising checking a delta in value between a composite grey associated with said at least one light source and implicitly adding said delta in value to an internal calibration value when a printing device is characterized for said color calibration in said normal office light.

16. The method for calibrating a printing device under at least one of office light and D50 illuminant of claim 14, further comprising representing said color calibration and said grey calibration in a touch screen utilizing a plurality of display patterns and responsive to user interaction.

17. The method for calibrating a printing device under at least one of office light and D50 illuminant of claim 14, further comprising printing a test pattern utilizing adjustments that can be accepted and rejected.

18. The method for calibrating a printing device under at least one of office light and D50 illuminant of claim 16, further comprising printing a test pattern utilizing adjustments that can be accepted and rejected.

19. A system for calibrating a printing device under at least one of office light and D50 illuminant, comprising:
a printing device including a Pan-Dimensional-Calibration (PDC) mechanism further comprising a calibration algorithm adapted to:
implement k grey calibration and then composite grey if a grey calibration has not been completed, otherwise calibrate color;
enable printing of a test pattern after implementing k grey and composite grey calibration to enable acceptance determination; and
determine delta in value between office light and D50 light if calibration is conducted under office light, otherwise enable printing of a test pattern after color calibration to enable acceptance determination.

20. The system for calibrating a printing device under at least one of office light and D50 illuminant of claim 19, further comprising a touch screen utilizing a plurality of display patterns and responsive to user interaction and access to a printing device for printing a test pattern utilizing adjustments that can be accepted and rejected.
